(19) United States
(12) Patent Application Publication
(10) Pub. No.: US 2008/0072925 A1
(43) Pub. Date: Mar. 27, 2008

(54) WAFER CLEANING APPARATUS

(75) Inventors: Mi-Seok PARK, Gyeonggi-do (KR); Young-Min KWON, Gyeonggi-do (KR); Jung-Hyun CHO, Gyeonggi-do (KR); No-Hyun HUH, Gyeonggi-do (KR); Soon-Hwan SUNG, Gyeonggi-do (KR)

Correspondence Address: MARGER JOHNSON & MCCOLLOM, P.C., 210 SW MORRISON STREET, SUITE 400, PORTLAND, OR, 97204, US

(73) Assignee: SAMSUNG ELECTRONICS CO., LTD., Gyeonggi-do (KR)

(21) Appl. No.: 11/834,549

(22) Filed: Aug. 6, 2007

(30) Foreign Application Priority Data
Aug. 4, 2006 (KR) 2006-73856

(51) Int. Cl. B08B 6/00

(52) U.S. Cl. 134/1.3; 134/105

(57) ABSTRACT

A wafer cleaning apparatus preferably includes a first plate configured to hold a wafer. The first plate may have a first supply pipe configured to supply a cleaning solution to a first surface of the wafer. A second plate preferably has a second supply pipe configured to supply the cleaning solution to a second surface of the wafer. A megasonic vibrator can be provided in the second plate. A plurality of heaters are preferably arranged in communication with one or both of the first and second plates. The plurality of heaters can be configured to heat the cleaning solution supplied to the first and second surfaces of the wafer. Using a wafer cleaning apparatus constructed according to principles of the present invention, a temperature difference of a cleaning solution can be reduced. An etch rate difference caused by the cleaning solution temperature difference can also be reduced to achieve a more uniform cleaning efficiency.

### CROSS-REFERENCE TO RELATED APPLICATIONS

This U.S. non-provisional patent application claims priority under 35 U.S.C. §119 of Korean Patent Application No. 2006-73856 filed on Aug. 4, 2006, the entirety of which is hereby incorporated herein by reference.

### BACKGROUND

The present invention relates to a wafer cleaning apparatus and, more particularly, to a wafer cleaning apparatus that uses a megasonic wave to clean a wafer.

With the trend toward higher integration of semiconductor devices, patterns are decreasing in size and their spaces are becoming narrower. Accordingly, a wafer cleaning process is becoming increasingly important because contaminant particles remaining on the surface of a wafer may cause a bad pattern in a subsequent process. Moreover, if contaminant particles remain between fine patterns, they may cause a malfunction of a semiconductor device. As fine patterns are becoming scaled down to below 1 micrometer, the allowable size of contaminant particles is further decreasing.

With conventional cleaning methods, it is difficult to remove minute contaminant particles. Accordingly, a variety of studies have been conducted to enhance cleaning efficiency. Generally, these studies have focused on effectively transferring a force to a cleaning solution to overcome strong viscosity of contaminant particles to a wafer.

One of these studies is disclosed in Korean Patent Publication No. 2006-70148. In that disclosure, a megasonic cleaner is provided to remove contaminant particles of a wafer by megasonically agitating a cleaning fluid. More specifically, in the megasonic cleaner, oscillation energy is transferred to respective areas of a wafer using two quartz rods. The use of multiple quartz rods minimizes a difference in cleaning efficiency between the edge and center of a wafer.

The megasonic cleaner may adopt other approaches to enhance a cleaning efficiency. For example, a megasonic wave can be applied equally to both surfaces of a wafer. Also, a cleaning solution may be heated before being supplied to a wafer. Unfortunately, when a heated cleaning solution is supplied to a wafer, there may be a temperature difference between the cleaning solution supplied to the edge of the wafer and the cleaning solution supplied to the center of the wafer. This temperature difference hinders a uniform cleaning efficiency. Accordingly, the industry would benefit from an improved megasonic cleaner that provides a more uniform cleaning efficiency.

### SUMMARY OF THE INVENTION

According to various principles of the present invention, a wafer cleaning apparatus may include a first plate provided to hold a wafer. A first supply pipe is preferably configured to supply a cleaning solution to a first surface of the wafer. A second plate can include a second supply pipe configured to supply the cleaning solution to a second surface of the wafer. A megasonic vibrator can also be provided to agitate the cleaning solution. A plurality of heaters are preferably configured to heat the cleaning solution supplied to the first and second surfaces of the wafer.

In one exemplary embodiment, the wafer cleaning apparatus may include a first plate having a first inner side and a first outer side. The first plate preferably holds a wafer with a first space defined between the first inner side and a first surface of the wafer. A second plate can also be provided having a second inner side and a second outer side. The second plate preferably faces the first plate to define a second space between the second inner side and a second surface of the wafer. A first cleaning solution supply pipe is preferably configured to supply a cleaning solution to the first space. A second cleaning solution supply pipe is preferably configured to supply a cleaning solution to the second space. A megasonic vibrator can be configured to supply a megasonic wave to the cleaning solution in the first and second spaces. A plurality of heaters are preferably configured to locally heat one or both of the first and second plates.

In another embodiment, the wafer cleaning apparatus may include a first plate configured to hold a wafer. A second plate is arranged facing the first plate with the wafer interposed between the first and second plates. A megasonic vibrator can be arranged in the second plate. A first supply pipe can be disposed through the first plate and configured to supply a cleaning solution to the wafer. A second supply pipe can be disposed through the second plate and configured to supply the cleaning solution to the wafer. In this embodiment, at least one of the first and second supply pipes preferably comprises a first injection port that supplies the cleaning solution to the center of the wafer and one or more second injection ports that supply the cleaning solution to the edge of the wafer.

According to another aspect of the present invention, a wafer cleaning method is also provided. In an exemplary embodiment, the wafer cleaning method may include mounting a wafer having a first surface and a second surface between first and second plates in a cleaning apparatus. A cleaning solution is supplied to a first space defined between the first plate and the first surface. The cleaning solution is also supplied to a second space defined between the second plate and the second surface. A megasonic wave is then supplied to the cleaning solution in the first and second spaces. One or both of the first and second plates can be locally heated to heat the cleaning solution.

In another embodiment, the wafer cleaning method may include mounting a wafer between a first plate and a second plate in a wafer cleaning apparatus to define a first space between the first plate and the wafer and a second space between the second plate and the wafer. The first and second spaces are then supplied with cleaning solution, wherein the cleaning solution supplied to one or both of the first and second spaces is supplied directly to both the center and the edge of the wafer through separate injection ports. A megasonic wave is also preferably supplied to the cleaning solution.

### BRIEF DESCRIPTION OF THE DRAWINGS

The foregoing and additional objects, features, and advantages of the present invention will become more readily apparent from the following detailed description of preferred embodiments, made with reference to the accompanying figures. Like numbers refer to like elements throughout the drawings, in which:

FIG. 1 is a somewhat schematic cross-sectional side view of a wafer cleaning apparatus according to one embodiment of the present invention;

FIG. 2 is a somewhat schematic top plan view of the wafer cleaning apparatus of FIG. 1, further illustrating the flow of a cleaning solution on a bottom plate of the wafer cleaning apparatus according to an aspect of the present invention;

FIG. 3 is a graph illustrating a difference in temperature of a cleaning solution between the center and the edge of a wafer where the plate is not heated;

FIG. 4 is a graph illustrating a difference in etch rate caused by temperature differences when a plate is not heated;

FIG. 5 is a somewhat schematic bottom plan view of the wafer cleaning apparatus of FIG. 1, showing a possible heater arrangement;

FIG. 6 is a somewhat schematic bottom plan view of the wafer cleaning apparatus of FIG. 1, showing another possible heater arrangement;

FIG. 7 is a graph illustrating a difference in temperature of a cleaning solution between the center and the edge of a wafer mounted in the wafer cleaning apparatus of FIG. 1 after heating a plate according to principles of the present invention;

FIG. 8 is a graph illustrating a difference in etch rate after heating a plate in the wafer cleaning apparatus of FIG. 1 according to principles of the present invention;

FIG. 9 is a somewhat schematic cross-sectional side view of a wafer cleaning apparatus according to another embodiment of the present invention;

FIGS. 10 and 11 are somewhat schematic top plan views of the wafer cleaning apparatus of FIG. 9, showing possible heater arrangements according to additional principles of the present invention;

FIG. 12 is a somewhat schematic cross-sectional side view of a wafer cleaning apparatus according to a further embodiment of the present invention;

FIG. 13 is a somewhat schematic cross-sectional side view of a wafer cleaning apparatus according to an additional embodiment of the present invention;

FIG. 14 is a somewhat schematic cross-sectional side view of a wafer cleaning apparatus according to a still further embodiment of the present invention;

FIG. 15 is a somewhat schematic cross-sectional side view of a wafer cleaning apparatus according to another embodiment of the present invention;

FIG. 16 is a somewhat schematic cross-sectional side view of a wafer cleaning apparatus according to yet another embodiment of the present invention; and

FIG. 17 is a somewhat schematic cross-sectional side view of a wafer cleaning apparatus according to another embodiment of the present invention.

### DETAILED DESCRIPTION OF PREFERRED EMBODIMENTS

The principles of the present invention will now be described more fully with reference to various preferred embodiments thereof. It should be noted, however, that this invention may be embodied in many different forms and should therefore not be construed as being limited to the particular embodiments set forth herein. Rather, these embodiments provide an enabling disclosure and set forth the best mode of practicing the invention to fully convey the scope of the invention to those skilled in the art.

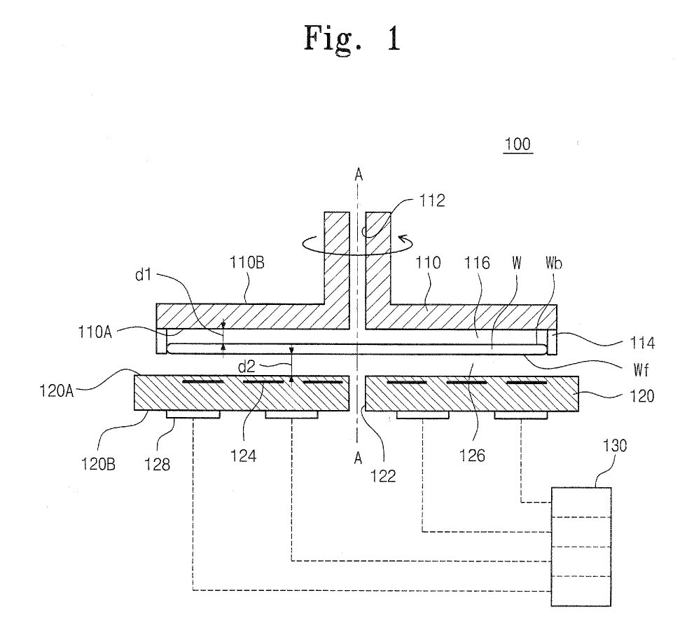

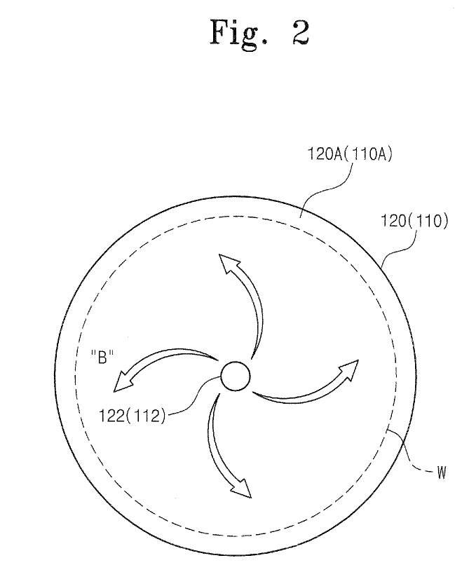

FIG. 1 is a somewhat schematic cross-sectional side view of a wafer cleaning apparatus 100 according to one embodiment of the present invention, and FIG. 2 is a somewhat schematic top plan view illustrating the flow of a cleaning solution on a bottom plate of the wafer cleaning apparatus 100. Referring to FIGS. 1 and 2, in the wafer cleaning apparatus 100, a cleaning solution and a megasonic wave are preferably supplied to both surfaces of a wafer W to clean the wafer W. It should be understood that the term “megasonic wave” generally refers to a wave having a frequency of about 1 megahertz (MHz) or higher.

Referring specifically to FIG. 1, the wafer cleaning apparatus 100 preferably includes a top plate 110 and a bottom plate 120. The top plate 110 can be rotatably configured to hold a wafer W and supply a cleaning solution to a back surface Wb of the wafer W. The bottom plate 120 can be configured to supply a cleaning solution to a front surface Wf of the wafer W and preferably functions as a flat oscillation plate. The top and bottom plates 110 and 120 may be designed to exhibit the same disk shape as the wafer W.

A plurality of pins 114 are preferably provided at an inner side 110A of the top plate 110 to fix the wafer W to the top plate 110. Since the inner side 110A of the top plate 110 faces downwardly, the pins 114 protrude downwardly from the inner side 110A of the top plate 110. The wafer W is preferably held such that its front surface Wf (where patterns are formed) faces downwardly and its back surface Wb faces upwardly. The inner side 110A of the top plate 110 is preferably spaced apart from the back surface Wb of the wafer W by a predetermined distance d1 to define a space 116. A cleaning solution supply pipe 112 may be disposed on a rotation axis line A-A through the top plate 110 to supply a cleaning solution to the space 116. The supply pipe 112 is thereby configured to supply cleaning solution to the back wafer surface Wb.

The bottom plate 120 is preferably installed below and parallel to the top plate 110. The inner side 110A of the top plate 110 and an inner side 120A of the bottom plate 120 thereby face each other. The inner side 120A of the bottom plate 120 can be spaced apart from the front surface Wf of the wafer W by a predetermined distance d2, thereby defining a second space 126. The rotation axis line A-A preferably runs through the center of the wafer W and the center of the bottom plate 120. A second cleaning solution supply pipe 122 can be installed on the rotation axis line A-A through the center of the bottom plate 120 to supply cleaning solution to the second space 126. The second supply pipe 122 is thereby configured to supply a cleaning solution to the front surface Wf of the wafer W.

A plurality of megasonic vibrators 124 can be disposed inside the bottom plate 120. Each megasonic vibrator 124 may, for instance, be a piezoelectric transducer. In this embodiment, the megasonic vibrators 124 are arranged to annularly cover the front surface Wf of the wafer W. The annular shapes of the megasonic vibrators 124 preferably overlap each other to uniformly transmit a megasonic wave to the front surface Wf of the wafer W.

The vertical positions of the top and bottom plates 110 and 120 can be varied in relation to each other. The distance d2 between the inner side 120A of the bottom plate 120 and the front surface Wf of the wafer W is therefore variable. For example, the top plate 110 may be elevated until the distance d2 reaches a desired distance (e.g., 1.5 millimeter). The distance d2 may be selected so as to achieve an optimal cleaning efficiency.

In operation, after the wafer W is fixed to the top plate 110 and the distance d2 is set to the desired distance, the top plate 110 is rotated with the wafer W. At the same time, a cleaning solution is preferably supplied through the first supply pipe 112 to fully fill the first space 116 with the cleaning solution and wet the back surface Wb of the wafer W. A cleaning solution can be simultaneously supplied through the second supply pipe 122 to fully fill the second space 126 and wet the front surface Wf of the wafer W. When the first and second spaces 116 and 126 are filled with cleaning solution, megasonic acoustic energy can then be applied to the cleaning solution using the plurality of megasonic vibrators 124. This vibration energy helps clean the surfaces Wf and Wb of the wafer W.

Referring now to FIG. 2, due to the rotatory force of the top plate 110, the cleaning solution filling the spaces 116 and 126 flows spirally from the center to the edge of the wafer W in a direction “B”. Although FIG. 2 indicates the flow with respect to the bottom plate 120, the flow of the cleaning solution on the top plate 110 is substantially identical to that on the bottom plate 120.

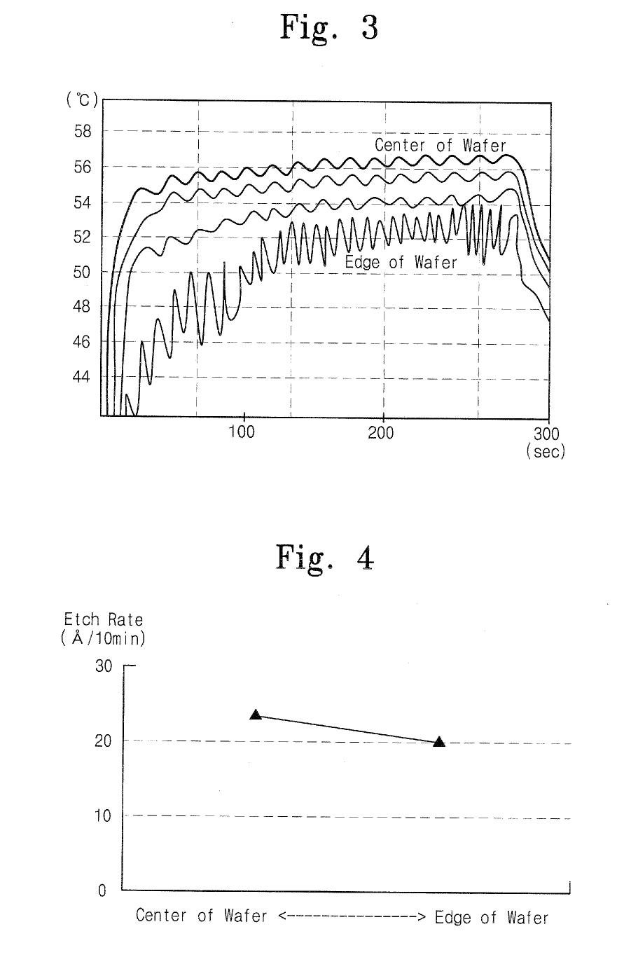

FIGS. 3 and 4 are comparative graphs illustrating the benefits of a wafer cleaning apparatus constructed and operated according to principles of the present invention. More specifically, FIG. 3 illustrates a difference in temperature between a cleaning solution supplied to the center of the wafer and the cleaning solution supplied to the edge of a wafer when the plate is not heated, and FIG. 4 illustrates an etch rate difference resulting from a temperature difference.

Referring to FIGS. 3 and 4, a cleaning solution may be heated (e.g., to between about 50-70 degrees centigrade) and used in a cleaning apparatus to enhance the efficiency of the cleaning process. Unfortunately, however, the cleaning solution cools while flowing between a bottom plate 120 and a wafer W, resulting in a difference between temperatures at the center and the edge of the wafer W. In FIG. 3, a deionized water (DI water), heated to a temperature of about 60 degrees centigrade, is used as the cleaning solution. In this example, because the heated cleaning solution is continuously supplied to the center of the wafer W, the temperature of the cleaning solution supplied to the center of the wafer W is approximately 60 degrees centigrade, in spite of the lapse of time. However, because the temperature of the cleaning solution decreases as it travels from the center to the edge of the wafer W, the cleaning solution supplied to the edge of the wafer W has a lower temperature than the cleaning solution supplied to the center of the wafer W This temperature difference becomes larger as the diameter of the wafer W increases or as the temperature of the cleaning solution increases.

Where SC1 is used as the cleaning solution, a temperature difference of the SC1 results in an etch rate difference. In FIG. 4, SC1 is heated to a temperature of 60 degrees centigrade and used as the cleaning solution. In this example, because of the temperature difference between the cleaning solution at the center and edge of the wafer, an etch rate (Å/10 min) at the edge of a wafer is lower than that at the center of the wafer. This difference in etch rate becomes larger as the diameter of the wafer increases.

Returning now to FIG. 1, a heater 128 heats the bottom plate 120 and thereby reduces a temperature difference of a cleaning solution in the wafer cleaning apparatus 100 constructed according to principles of the present invention. More specifically, in this embodiment, a plurality of heaters 128 can be provided in the form of hot pad, suitably located at the outer side 120B of the bottom plate 120. The plurality of heaters 128 can be spaced apart at regular intervals and independently controlled by a temperature controller 130 to locally heat specific areas of the bottom plate 120 by an appropriate amount to maintain the temperature of the cleaning solution.

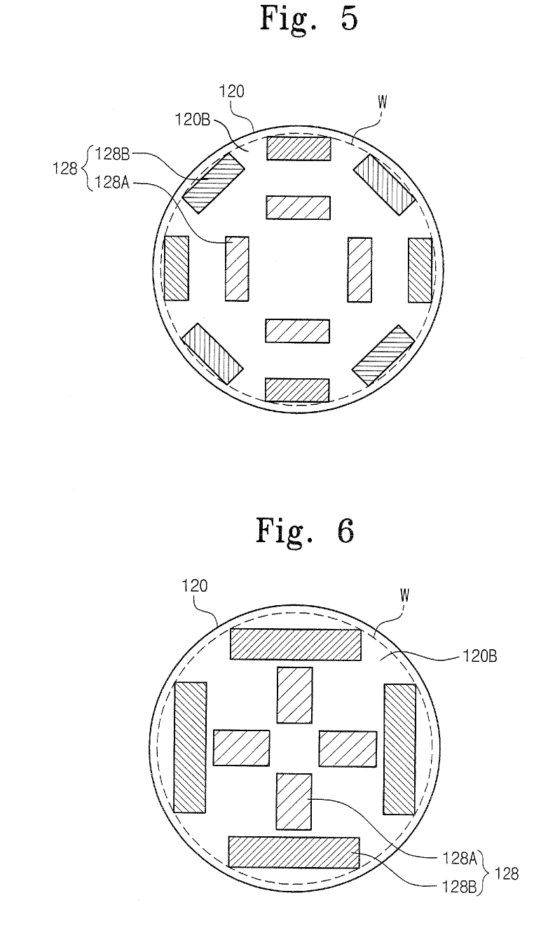

FIGS. 5 and 6 are bottom views of the wafer cleaning apparatus 100 of FIG. 1, showing two examples of possible heater arrangements according to principles of the present invention. Referring to FIG. 5, heaters 128 can be arranged at the outer side 120B of a bottom plate 120 in two or more different groups. For example, four heaters 128A can be arranged in a first group to heat a cleaning solution supplied to the center of the wafer W. Eight additional heaters 128B can be arranged in a second group to heat a cleaning solution that flows to the edge of the wafer W. Since the cleaning solution supplied to the center of a wafer W generally cools while flowing to the edge of the wafer W, the number of heaters 128B arranged at the edge of the wafer W may be larger than that of heaters 128A at the center of the wafer W. As further shown in FIG. 6, in an alternative embodiment, the first and second groups may include the same number of heaters, but an area heated by a heater 128B in the second group may be larger than an area heated by a heater 128A in the first group.

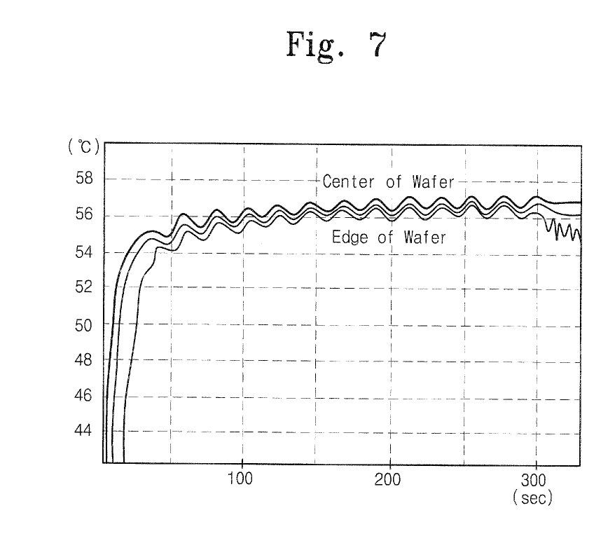

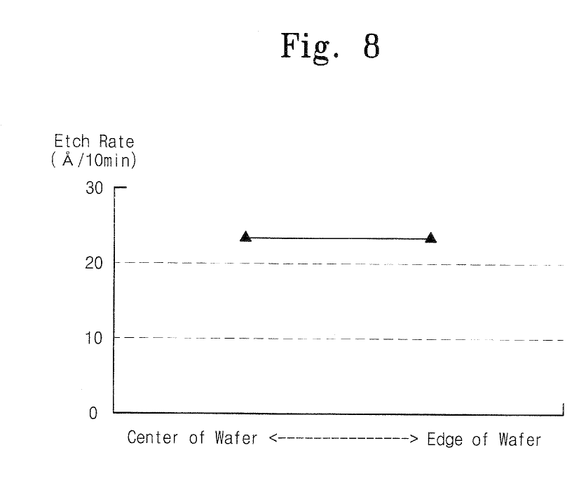

FIGS. 7 and 8 are graphs illustrating a temperature difference and an etch rate difference, respectively, of a cleaning solution supplied to the wafer while heating a plate in the wafer cleaning apparatus according to principles of the present invention. As shown in FIG. 1 and explained above, the heater 128 locally heats a bottom plate 120, transferring a heat to the cleaning solution supplied to spaces 116 and 126 from the bottom plate 120. Thus, a temperature of the cleaning solution supplied to the center of a wafer W and a temperature of the cleaning solution flowing to the edge of the wafer W can be constantly maintained.

As can be seen from FIG. 7, where DI water heated to a temperature of 60 degrees centigrade is used as the cleaning solution in a wafer cleaning apparatus constructed and operated according to principles of the present invention, there is no practical difference between a temperature of the cleaning solution supplied to the center of a wafer W and a temperature of the cleaning solution at the edge of the wafer W. And, as illustrated in FIG. 8, even if heated SC1 is used as the cleaning solution, because the temperature of the cleaning solution is maintained across the wafer W, the etch rate (Å/10 min) also maintains a substantially constant value across the wafer W.

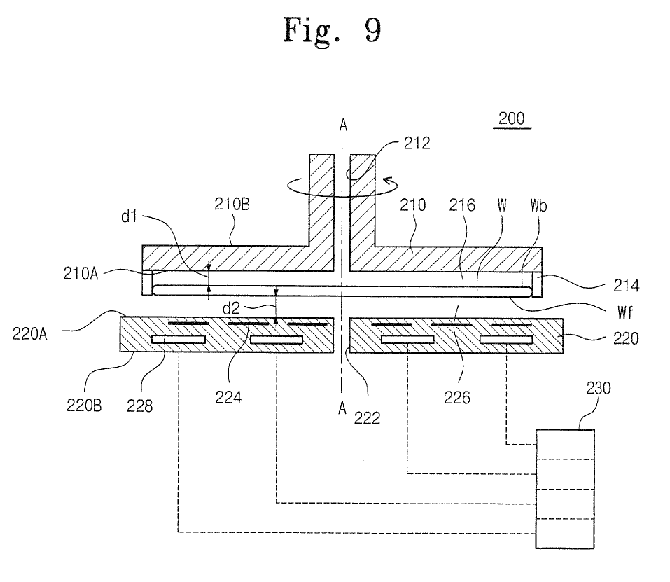

FIG. 9 is a somewhat schematic cross-sectional side view of a wafer cleaning apparatus 200 according to an alternative embodiment of the present invention. This wafer cleaning apparatus 200 is similar to the previously described wafer cleaning apparatus 100, except with respect to the heater configuration. Accordingly, although these different heater configurations will be described in some detail, a detailed repetition of features or aspects previously described will be omitted.

Referring to FIG. 9, the wafer cleaning apparatus 200 preferably includes a top plate 210 and a bottom plate 220. The top plate 210 is configured to hold a wafer W and supply a cleaning solution to a space 216 through a first supply pipe 212. The bottom plate 220 comprises a plurality of vibrators 224 arranged therein to function as an oscillation plate. The bottom plate 220 is further configured to supply a cleaning solution to a space 226 through a second supply pipe 222. The wafer W is held to the top plate 210 by means of pins 214, and therefore spins with the rotation of the top plate 210. A plurality of heaters 228 can be arranged in the bottom plate 220. The plurality of heaters 228 may be in the form of a heating coil or concentric heating rings. The plurality of heaters 228 are preferably independently controlled by a temperature controller 230 to locally heat specific areas of the bottom plate 220 to maintain a temperature of a cleaning solution across the wafer W.

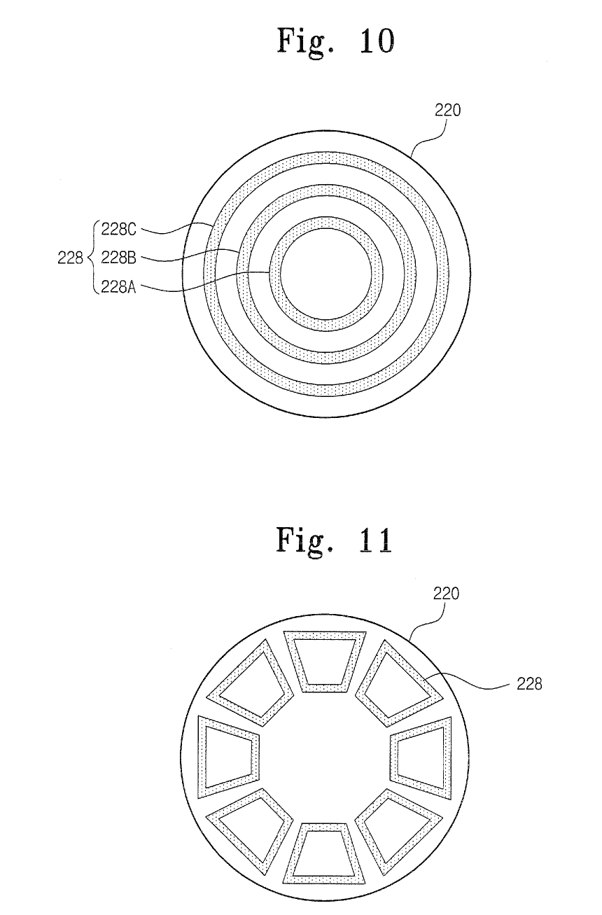

FIGS. 10 and 11 are somewhat schematic top plan views illustrating potential heater arrangements in the wafer cleaning apparatus 200. Referring first to FIG. 10, the heaters 228 located in the bottom plate 220 can be circular-shaped heaters arranged concentrically to heat different areas of the plate 220. For instance, an inner heater 228A can be arranged near the center of the plate 220 to heat a cleaning solution supplied to the center of a wafer W. An outer heater 228C can be located near the outer edge of the plate 220 to heat a cleaning solution supplied to the edge of the wafer W. And one or more intermediate heaters 228B may be provided between the inner and outer heaters 228A, 228C to heat a cleaning solution supplied between the center and the edge of the wafer W. Referring to FIG. 11, in an alternative embodiment, the heaters 228 may be trapezoidally-shaped heaters arranged in a circle around the plate 220.

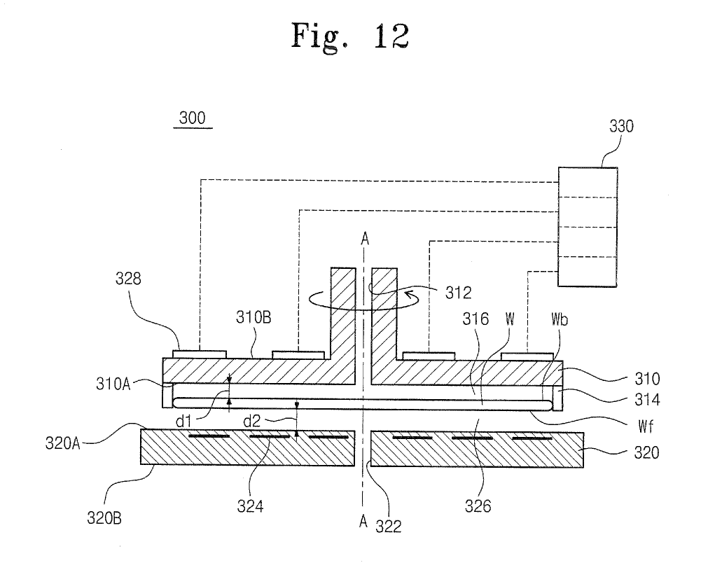

FIG. 12 is a somewhat schematic cross-sectional side view of a wafer cleaning apparatus 300 according to yet another embodiment of the present invention. The wafer cleaning apparatus 300 is also similar to the initially-described wafer cleaning apparatus 100, except with respect to the configuration of the heaters. Accordingly, only the variations arising from those different configurations will be described herein in detail.

Referring to FIG. 12, the wafer cleaning apparatus 300 includes a top plate 310 and a bottom plate 320. The top plate 310 is configured to hold a wafer W and supply a cleaning solution to a space 316 through a first supply pipe 312. The bottom plate 320 includes a plurality of vibrators 324 to function as an oscillation plate. The bottom plate 320 is further configured to supply a cleaning solution to a space 326 through a second supply pipe 322. The wafer W is held to the top plate 310 by pins 314 and spins with the rotation of the top plate 310. A plurality of heaters 328 are preferably attached to an outer side 310B of the top plate 310. Each of the plurality of heaters 328 may be a hot pad suitably attached to the outer side 310B of the top plate 310. Each of the plurality of heaters 328 is preferably independently controlled by a temperature controller 330 to locally heat a specific area of the top plate 310 to maintain a temperature of the cleaning solution across the wafer W. The heaters 328 may be arranged, for example, in a configuration similar to that shown in FIG. 5 or FIG. 6.

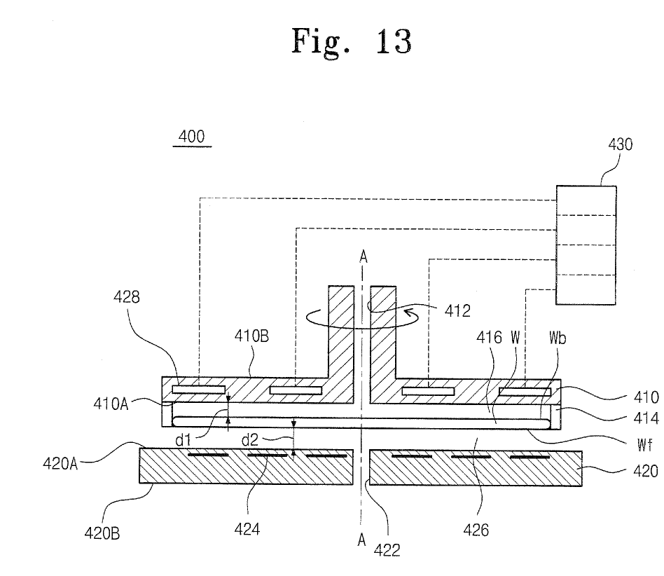

FIG. 13 is a somewhat schematic cross-sectional side view of a wafer cleaning apparatus 400 according to yet another embodiment of the present invention. The wafer cleaning apparatus 400 is similar to the wafer cleaning apparatus 100 described initially, except with respect to the configuration of the heaters. Therefore, only the variations will be described in detail.

Referring to FIG. 13, the wafer cleaning apparatus 400 includes a top plate 410 and a bottom plate 420. The top plate 410 is configured to hold a wafer W and supply a cleaning solution to a space 416 through a first supply pipe 412. The bottom plate 420 comprises a plurality of vibrators 424 to function as an oscillation plate and supplies a cleaning solution to a space 426 through a second supply pipe 422. The wafer W is held to the top plate 410 by pins 414, and spins with the top plate 410. A plurality of heaters 428 are arranged in the top plate 410. The plurality of heaters 428 may, for instance, be arranged as a coil or in concentric circles, suitably integrated into the top plate 410. The plurality of heaters 428 are preferably independently controlled by a temperature controller 430 to locally heat specific areas of the top plate 410. These heaters 428 may be arranged, for instance, as illustrated in FIG. 10 or FIG. 11.

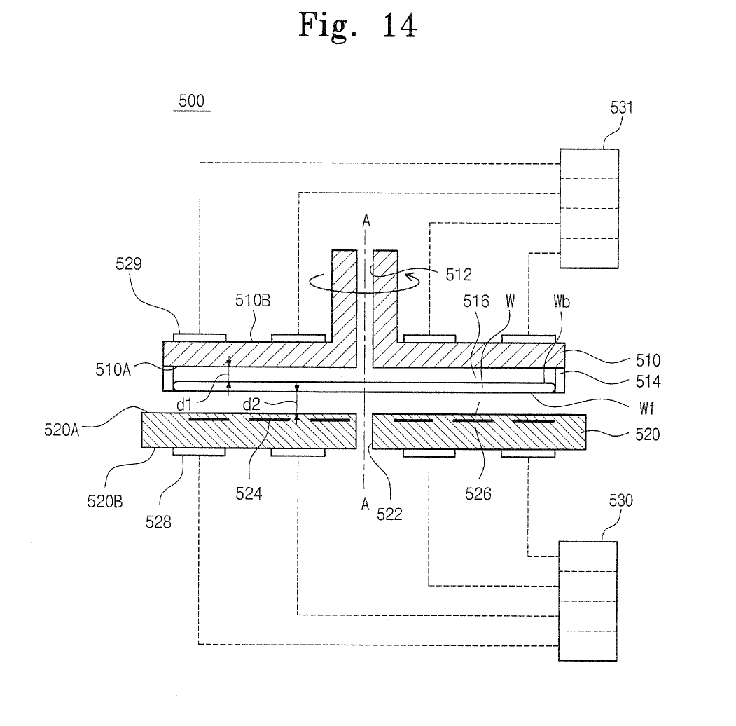

FIG. 14 is a somewhat schematic cross-sectional side view of a wafer cleaning apparatus 500 according to a still further embodiment of the present invention. Again, the wafer cleaning apparatus 500 is similar to the wafer cleaning apparatus 100 initially described. Accordingly, only the differences in the configurations will be described in detail.

Referring to FIG. 14, the wafer cleaning apparatus 500 includes a top plate 510 and a bottom plate 520. The top plate 510 is configured to hold a wafer W using pins 514. A cleaning solution is supplied to a first space 516 through a first supply pipe 512. The bottom plate 520 has a plurality of vibrators 524 and functions as an oscillation plate. A cleaning solution is supplied to a second space 526 through a second supply pipe 522. The wafer W spins with the rotation of the top plate 510.

A first plurality of heaters 529 can be suitably attached to the outer side 510B of the top plate 510. Each of the first plurality of heaters 529 may be a hot pad that is independently controlled by a temperature controller 530 to locally heat specific areas of the top plate 510. In addition, a second plurality of heaters 528 may be attached to the outer side 510A of the bottom plate 520. Each of the second plurality of heaters 528 is preferably independently controlled by the temperature controller 530 to locally heat specific areas of the bottom plate 520. The heaters 528 and 529 may be arranged, for instance, as illustrated in FIG. 5 or FIG. 6.

Of course, various alternative configurations are also possible. For instance, the first plurality of heaters 529 installed on the top plate 510 may be hot pads attached to the outer side 510B of the top plate 529, while the second plurality of heaters 528 installed on the bottom plate 520 may be constructed inside the bottom plate 520 in the form of a coil or concentric circles, for instance. In another embodiment, the first plurality of heaters 529 may be arranged inside the top plate 510 in the form of coil or concentric circles, for instance, while the second plurality of heaters 528 may be hot pads attached to the outer side 520B of the bottom plate 520.

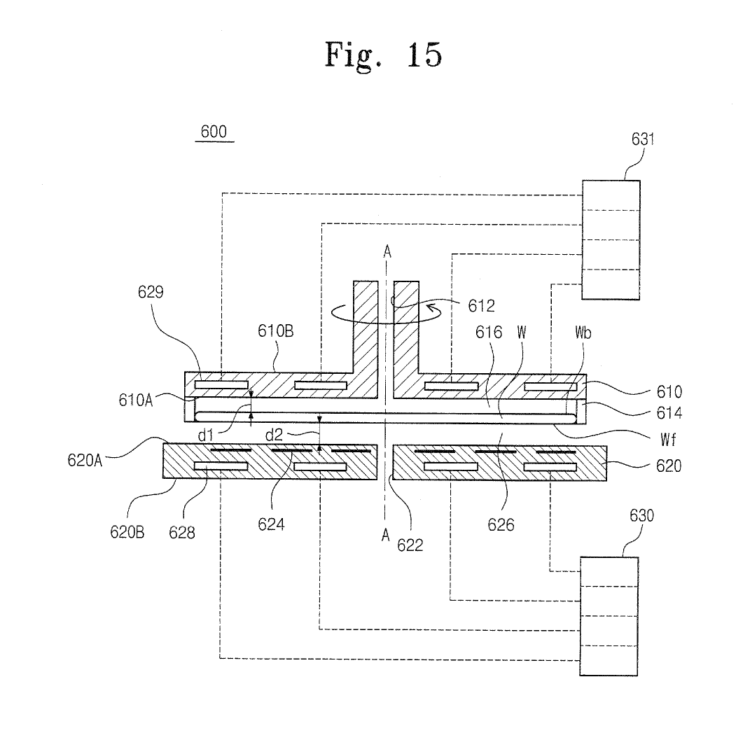

FIG. 15 is a somewhat schematic cross-sectional side view of a wafer cleaning apparatus 600 according to yet another embodiment of the present invention. Referring to FIG. 15, the wafer cleaning apparatus 600 includes a top plate 610 and a bottom plate 620. The top plate 610 is preferably configured to hold a wafer W using pins 614 and to supply a cleaning solution to a first space 616 through a first supply pipe 612. The bottom plate 620 preferably includes a plurality of vibrators 624 and is configured to supply a cleaning solution to a second space 626 through a second supply pipe 622. The wafer W spins with the top plate 610.

A first plurality of heaters 629 are preferably constructed in the top plate 610. The first plurality of heaters 629 may be provided in the form of coil or concentric circles, for instance. This plurality of heaters 629 are each preferably independently controlled by a temperature controller 631 to locally heat specific areas of the top plate 610. Similarly, a second plurality of heaters 628 may be constructed in the bottom plate 620. The second plurality of heaters 628 may also be arranged in the form of coil or concentric circles, for instance. This plurality of heaters 628 can be independently controlled by the temperature controller 630 to locally heat specific areas of the bottom plate 620. These heaters 628 and 629 may, for instance, be arranged as illustrated in FIG. 10 or FIG. 11.

Alternatively, the first plurality of heaters 629 may be hot pads attached to the outer side 610B of the top plate 610 with the second plurality of heaters 628 installed inside the bottom plate 620. In yet another variation, the first plurality of heaters 629 may be constructed inside the top plate 610 with the second plurality of heaters 628 comprising hot pads attached to the outer side 620B of the bottom plate 620.

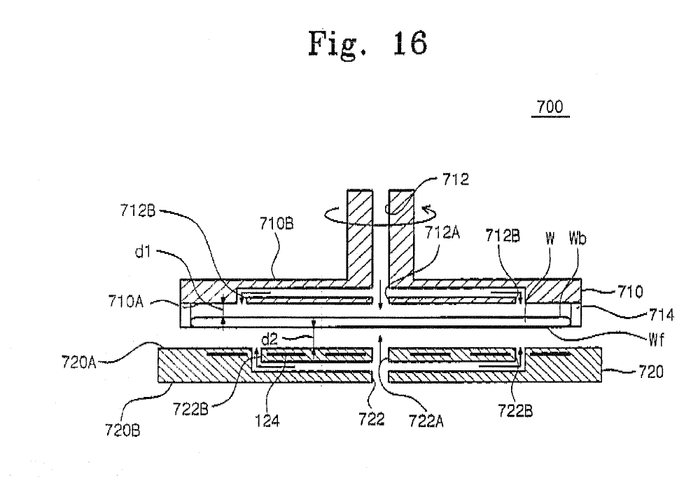

FIG. 16 is a somewhat schematic cross-sectional side view of a wafer cleaning apparatus 700 according to another embodiment of the present invention. Referring to FIG. 16, the wafer cleaning apparatus 700 includes a top plate 710 and a bottom plate 720. The top plate 710 is configured to hold a wafer W using pins 714 and to supply a cleaning solution to a first space 716 through a first supply pipe 712. The bottom plate 720 includes a plurality of vibrators 724 constructed therein and functions as an oscillation plate. The bottom plate is also configured to supply a cleaning solution to a second space 326 through a second supply pipe 722. The wafer W spins with the rotation of the top plate 710.

The first supply pipe 712 installed through the top plate 710 preferably includes a first injection port 712A configured to supply a cleaning solution to the center of the wafer W and one or more second injection ports 712B configured to supply a cleaning solution to the edge of the wafer W. Similarly, the second supply pipe 722 installed through the bottom plate 720 may include a first injection port 722A configured to supply a cleaning solution to the center of a wafer W and one or more second injection ports 722B configured to supply a cleaning solution to the edge of the wafer W.

In operation, cleaning solution supplied to the supply pipe 712 is supplied to the center of the wafer W through the first injection port 712A and to the edge of the wafer W through the one or more second injection ports 712B. In this manner, heated cleaning solution may be supplied to both the center and the edge of the wafer W simultaneously to reduce or substantially eliminate a temperature difference of the cleaning solution communicating with respective areas of the wafer W. The operation of the injection ports 722A and 722B in the bottom plate 720 is similar to the injection ports 712A and 722B in the top plate 710.

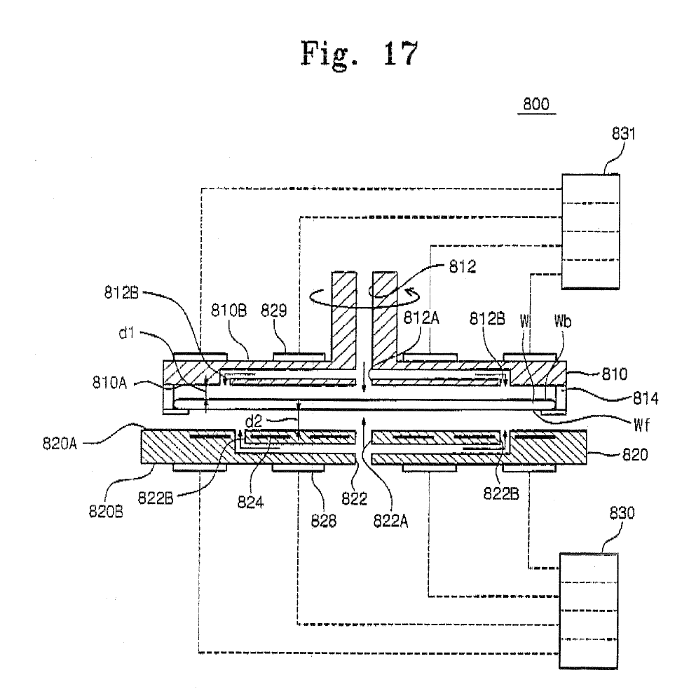

FIG. 17 is a somewhat schematic cross-sectional side view of a wafer cleaning apparatus 800 according to a yet further embodiment of the present invention. Referring to FIG. 17, the wafer cleaning apparatus 800 includes a top plate 810 and a bottom plate 820. The top plate 810 is configured to hold a wafer W using pins 814 and to supply a cleaning solution to a first space 816 through a first supply pipe 812. The bottom plate 820 contains a plurality of vibrators 824 and is configured to supply a cleaning solution to a second space 826 through a second supply pipe 822. The wafer W spins with the plate 810.

The first supply pipe 812 preferably includes a central injection port 812A configured to supply cleaning solution to the center of the wafer W and one or more peripheral injection ports 812B configured to supply cleaning solution to the edge of the wafer W. Similarly, the second supply pipe 822 may include a central injection port 822A configured to supply cleaning solution to the center of the wafer W and one or more peripheral injection ports 822B to supply cleaning solution to the edge of the wafer W.

A first plurality of heaters 829 are preferably attached to the outer side 810B of the top plate 810. Each of the first plurality of heaters 829 may be a hot pad that is independently controlled by a temperature controller 831 to locally heat a specific area of the top plate 810. Similarly, a second plurality of heaters 828 can be attached to the outer side 810A of the bottom plate 820. Each of the second plurality of heaters 828 can also be independently controlled by the temperature controller 830 to locally heat specific areas of the bottom plate 820. These heaters 828 and 829 may, for instance, be arranged as illustrated in FIG. 5 or FIG. 6. The temperature of the cleaning solutions supplied to the injection ports 812A and 812B may be controlled by the first plurality of heaters 829. Similarly, the temperature of the cleaning solutions supplied to the injection ports 822A and 822B may be controlled by the second plurality of heaters 828.

In an alternative configuration, the first plurality of heaters 829 may be hot pads attached to the outer side 810B of the top plate 810 while the second plurality of heaters 828 may, for instance, be a coil or concentric circles arranged inside the bottom plate 820. Alternatively, the first plurality of heaters 829 may, for instance, be a coil or concentric circles arranged inside the top plate 810 with the second plurality of heaters 828 being hot pads attached to the outer side 820B of the bottom plate 820.

In this embodiment, since the cleaning solution is supplied to the wafer after branching off at the injection ports 812A-822B, a temperature difference of the cleaning solution between the center and the edge of the wafer W can be substantially eliminated. In addition, while the cleaning solution is supplied and/or a megasonic wave is applied, the top and bottom plates 810 and 820 can be selectively heated to further reduce or eliminate a temperature difference of the cleaning solution.

According to various principles of the present invention, a plurality of independently controllable heaters can be installed on or in the top and/or bottom plate. The heaters may, for instance, take the form of a hot pad, a coil, circularly arranged trapezoidally-shaped heaters, or concentrically arranged circular-shaped heaters. In an alternative arrangement, a plurality of cleaning solution supply pipes can be provided to form a plurality of cleaning solution flow passages that supply heated cleaning solution directly to different areas of the wafer. In a still further configuration, a combination of heated plates and multiple flow passages can be used. In each case, it is possible to substantially prevent a heated cleaning solution from being cooled while flowing to the edge of a wafer. As a result, an etch rate difference caused by a cleaning solution temperature difference can be reduced or eliminated to achieve a more uniform cleaning efficiency.

Although the present invention has been described in connection with multiple preferred embodiments of the present invention, the invention is not limited thereto. It will be apparent to those skilled in the art that various substitutions, modifications and changes may be made to the embodiments described herein without departing from the scope and spirit of the invention. The claims are therefore to be interpreted in light of the principles disclosed herein and are not to be limited to the specific embodiments.

What is claimed is:

1. A wafer cleaning apparatus comprising:
a first plate configured to hold a wafer;
a first supply pipe arranged in the first plate and configured to supply cleaning solution to a first surface of the wafer;
a second plate arranged below the first plate;
a second supply pipe arranged in the second plate and configured to supply cleaning solution to a second surface of the wafer;
a megasonic vibrator arranged in the second plate; and
a plurality of heaters configured to heat the cleaning solution supplied to the first and second surfaces of the wafer.

2. The wafer cleaning apparatus of claim 1, wherein the plurality of heaters are arranged in communication with one or both of the first and second plates.

3. The wafer cleaning apparatus of claim 2, wherein the plurality of heaters are configured to locally heat at least one of the first and second plates.

4. The wafer cleaning apparatus of claim 3, further comprising:
a temperature controller configured to independently control each of the plurality of heaters.

5. The wafer cleaning apparatus of claim 3, wherein the plurality of heaters are arranged on an outer side of at least one of the first and second plates.

6. The wafer cleaning apparatus of claim 3, wherein the plurality of heaters are constructed inside at least one of the first and second plates.

7. The wafer cleaning apparatus of claim 3, wherein the plurality of heaters comprise:
a first plurality of heaters arranged on an outer side of one of the first and second plates; and
a second plurality of heaters constructed inside the other one of the first and second plates.

8. The wafer cleaning apparatus of claim 1, wherein the first plate is rotatable.

9. The wafer cleaning apparatus of claim 1, wherein the first plate comprises a plurality of pins for holding the wafer.

10. The wafer cleaning apparatus of claim 1, wherein at least one of the first and second supply pipes includes a plurality of flow paths through which the cleaning solution travels to be supplied to different locations along the wafer.

11. A wafer cleaning apparatus comprising:
a first plate having a first inner side and a first outer side, wherein said first plate is configured to hold a wafer;
a first space defined between the first inner side and a first surface of the wafer;
a second plate having a second inner side and a second outer side, wherein said second plate is configured to face the first plate;
a second space defined between the second inner side and a second surface of the wafer;
a first cleaning solution supply pipe configured to supply a cleaning solution to the first space;
a second cleaning solution supply pipe configured to supply a cleaning solution to the second space;
a megasonic vibrator configured to supply a megasonic wave to the cleaning solution supplied to the first and second spaces; and
a plurality of heaters configured to locally heat one or more of the first and second plates.

12. The wafer cleaning apparatus of claim 12, further comprising a temperature controller configured to independently control each of the plurality of heaters.

13. The wafer cleaning apparatus of claim 11, wherein the plurality of heaters comprises a plurality of hot pads attached to at least one of the first and second outer sides.

14. The wafer cleaning apparatus of claim 11, wherein the plurality of heaters comprises a plurality of heating coils constructed inside one of the first and second plates.

15. The wafer cleaning apparatus of claim 11, wherein the plurality of heaters comprise:
a plurality of hot pads attached to an outer side of one of the first and second plates; and
a plurality of heating coils constructed inside the other one of the first and second plates.

16. The wafer cleaning apparatus of claim 11, wherein the first supply pipe is disposed through a center of the first plate.

17. The wafer cleaning apparatus of clam 16, wherein the first supply pipe comprises:
a first injection port for supplying the cleaning solution to a center of the first surface of the wafer; and
one or more second injection ports for supplying the cleaning solution to an edge of the first surface of the wafer.

18. The wafer cleaning apparatus of claim 11, wherein the second supply pipe is disposed through a center of the second plate.

19. The wafer cleaning apparatus of claim 18, wherein the second pipe comprises:
a first injection port for supplying the cleaning solution to a center of the second surface of the wafer; and
at least one second injection port for supplying the cleaning solution to an edge of the second surface of the wafer.

20. The wafer cleaning apparatus of claim 11, wherein the megasonic vibrator comprises a plurality of piezoelectric transducers arranged in the second plate.

21. The wafer cleaning apparatus of claim 11, wherein the first plate is rotatable.

22. The wafer cleaning apparatus of claim 11, wherein the first plate comprises a plurality of pins protruding from the first inner side to hold the wafer.

23. A wafer cleaning apparatus comprising:
a first plate configured to hold a wafer;
a second plate facing the first plate with the wafer interposed therebetween;
a megasonic vibrator arranged in communication with the second plate;
a first supply pipe disposed through the first plate, said first supply pipe configured to supply cleaning solution to the wafer; and
a second supply pipe disposed through the second plate, said second supply pipe configured to supply cleaning solution to the wafer,
wherein at least one of the first and second supply pipes comprises:
a first injection port for supplying cleaning solution to a center of the wafer; and
a second injection port for supplying cleaning solution to an edge of the wafer.

24. The wafer cleaning apparatus of claim 23, wherein the first plate is rotatable.

25. The wafer cleaning apparatus of claim 23, wherein the first plate comprises a plurality of pins configured to hold the wafer.

26. The wafer cleaning apparatus of claim 23, further comprising a plurality of heaters configured to locally heat at least one of the first and second plates.

27. The wafer cleaning apparatus of claim 26, further comprising a temperature controller configured to independently control the plurality of heaters.

28. The wafer cleaning apparatus of claim 26, wherein the plurality of heaters comprise a plurality of hot pads attached to the outer side of at least one of the first and second plates, a plurality of heating coils constructed inside at least one of the first and second plates, or a combination of hot pads attached to the outer side of one of the first and second plates and heating coils constructed inside the other plate.

29. A wafer cleaning method comprising:
mounting a wafer having a first surface and a second surface between a first plate and a second plate;
supplying cleaning solution to a first space defined between the first plate and the first surface of the wafer;
supplying cleaning solution to a second space defined between the second plate and the second surface of the wafer;
applying a megasonic wave to cleaning solution supplied to the first and second spaces; and
locally heating at least one of the first and second plates.

30. The wafer cleaning method of claim 29, further comprising spinning the wafer.

31. The wafer cleaning method of claim 29, wherein supplying cleaning solution to the first space comprises supplying a heated cleaning solution from a first cleaning solution supply pipe arranged through a center of the first plate to wet the first surface of the wafer.

32. The wafer cleaning method of claim 31, further comprising simultaneously supplying the heated cleaning solution from the first cleaning solution supply pipe to the center and an edge of the first surface.

33. The wafer cleaning method of claim 29, wherein supplying cleaning solution to the second space comprises supplying a heated cleaning solution from a second cleaning solution supply pipe disposed through a center of the second plate to wet the second surface.

34. The wafer cleaning method of claim 33, further comprising simultaneously supplying the heated cleaning solution from the second cleaning solution supply pipe to the center and an edge of the second surface.

35. The wafer cleaning method of claim 29, wherein locally heating at least one of the first and second plates comprises independently controlling a plurality of heaters communicating with at least one of the first and second plates to independently heat local areas of at least one of the first and second plates.

36. A wafer cleaning method comprising:
mounting a wafer between a first plate and a second plate to define a first space between the first plate and the wafer and a second space between the second plate and the wafer;
supplying a cleaning solution to the first and second spaces, wherein the cleaning solution supplied to at least one of the first and second spaces is directly supplied to a center and an edge of the wafer respectively; and
applying a megasonic wave to the cleaning solution.

37. The wafer cleaning method of claim 36, wherein the cleaning solution is a heated cleaning solution.

38. The wafer cleaning method of claim 36, further comprising spinning the wafer.

39. The wafer cleaning method of claim 36, further comprising locally heating at least one of the first and second plates.

40. The wafer cleaning method of claim 36, wherein the locally heating at least one of the first and second plates is performed substantially simultaneously with at least one of supplying the cleaning solution and applying the megasonic wave.
